(19) United States
(12) Patent Application Publication
(10) Pub. No.: US 2007/0144947 A1
(43) Pub. Date: Jun. 28, 2007

(54) Method and apparatus for forwarding a mail item

(75) Inventor: Walter Rosenbaum, Paris (FR)

Correspondence Address: SIEMENS SCHWEIZ AG;I-47, INTELLECTUAL PROPERTY, ALBISRIEDERSTRASSE 245, ZURICH, CH-8047, CH

(73) Assignee: Seimens Aktiegesellschaft, Munich (DE)

(21) Appl. No.: 10/579,845

(22) PCT Filed: Nov. 15, 2004
(86) PCT No.: PCT/EP04/12915

§ 371 Date: May 17, 2006

Related U.S. Application Data
(60) Provisional application No. 60/520,658, filed on Nov. 18, 2003.

(51) Int. Cl. B07C 5/00

(52) U.S. Cl. 209/584

(57) ABSTRACT

In a device for singulating vertically positioned flat mailings from a stack of mail, at least two discharge rockers are disposed on top of one another. The discharge rockers are adjacent to revolving second discharge belts that are arranged in a fixed manner along the path of travel. A supporting element in relation to which the stack of mail is aligned ends at a defined distance from the undeflected discharge rockers. A flexible, elongated retaining element is arranged in a resiliently pressed manner from the end of the supporting element to the beginning of the second discharge belts located downstream of the discharge rockers and further on to the discharge rockers and to further discharge belts of successive singulating stages. The distance of the supporting element from the leading end of the second discharge belts relative to the direction of travel is greater than the maximum permissible length of a mailing.

### CROSS REFERENCE TO RELATED APPLICATIONS

The present invention claims priority to provisional patent application Ser. No. 60/520,658, filed Nov. 18, 2003, which is herein incorporated by reference.

### BACKGROUND OF THE INVENTION

The present invention relates to the field of article handling and more particularly to a system and method for redirecting articles with advanced payment or guarantee of payment from the article's recipient. The articles may include postal articles and for purposes of explanation, the present invention will be discussed with application to mail handling. However, it should be understood that the instant method may be applied to other articles as envisioned by one skilled in the art.

Mail redirection, commonly known as forwarding, entails the redirecting of post to an addressee's new address. A common initiation of this process is the handwriting of a new address across the address face of a mail piece. The mail piece is then redeposited into the mail stream for a second delivery to the hand written address. New postage is normally not affixed to the mail piece, nor is the mail piece normally opened. These steps are depicted in FIG. 1. This process is also referred to as Ad Hoc Forwarding.

A postal delivery service will typically perform the second delivery as a courtesy despite the lack of postage and accordingly, lack of payment. When taken on a large scale, such second deliveries provide a financial burden postal delivery services which may equate into overall higher postage costs, degradation of services, and the like. In response, several postal services have initiated a fee for such second deliveries or forwarding or redirection. However, this solution carries with it additional burdens including the detection of a redirected mail piece and the collection of funds for the redirection.

### SUMMARY OF THE INVENTION

An advantage of the present invention is to facilitate the redirection of articles, such as mail pieces, facilitate collection of fees due for such redirecting, and alleviate the burden on unnecessary deliveries and mail handling.

These and other advantages are effected by a system and method for redirecting mail, wherein an incoming mail piece is automatically scanned and the picked up data used to determine if the mail piece is a redirected one. If the mail piece is for redirection, an automatic determination is made as to whether the addressee has an account to cover the costs of such redirection. If the account is determined to exist, the mail piece is routed according to its new delivery address and the account automatically and appropriately debited. If no account exists, the addressee is notified of a redirected mail piece awaiting attention and offered the opportunity to establish such an account. After a preset time, if no account is established, the mail piece is destroyed. The aforementioned is also effected via automatic means.

The advantages are further effected by a method of forwarding post, comprising the steps of determining if a current post destination address is expired, if said destination address is expired, determining if an addressee of said post maintains a forwarding service, and if said forwarding service is maintained, forwarding said post to an addressee destination address.

The advantages are still further effected by an apparatus for forwarding post, comprising: means for determining if a current post destination address is expired, means for determining if an addressee of said post maintains a forwarding service if said destination address is expired, and means for forwarding said post to an addressee destination address if said forwarding service is maintained.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawings, wherein:

FIG. 1 depicts a prior art method of forwarding mail which creates an Ad Hoc forwarding transaction;

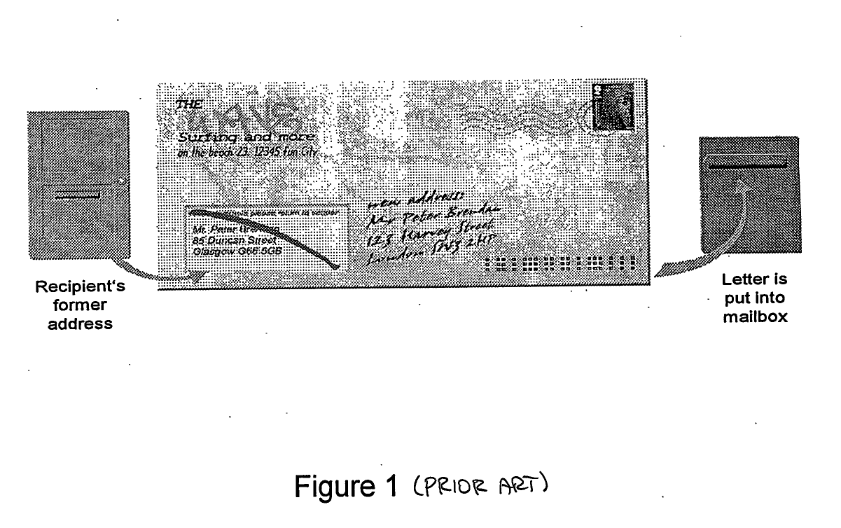

FIG. 2 depicts a reading of mail piece TID which has expired and thereby flags a mail piece as having reentered the mail processing stream after an initial attempt at delivery;

FIG. 3 depicts video encoding of a mail piece that includes entry of the new redirection address as well as the addressee's prior address;

FIG. 4 depicts addressee notification upon entry (of the respective former) and current addresses into the database;

FIG. 5 depicts mail piece destruction if Redirection Service declined; and

FIG. 6 depicts a flowchart for performing the present invention.

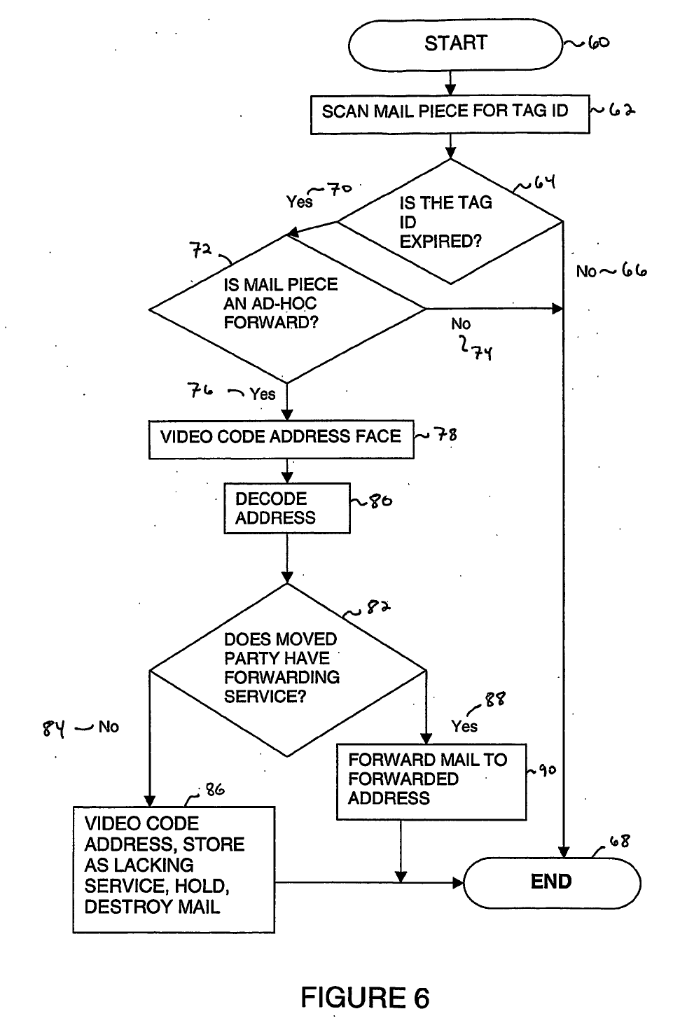

### DETAILED DESCRIPTION OF THE INVENTION

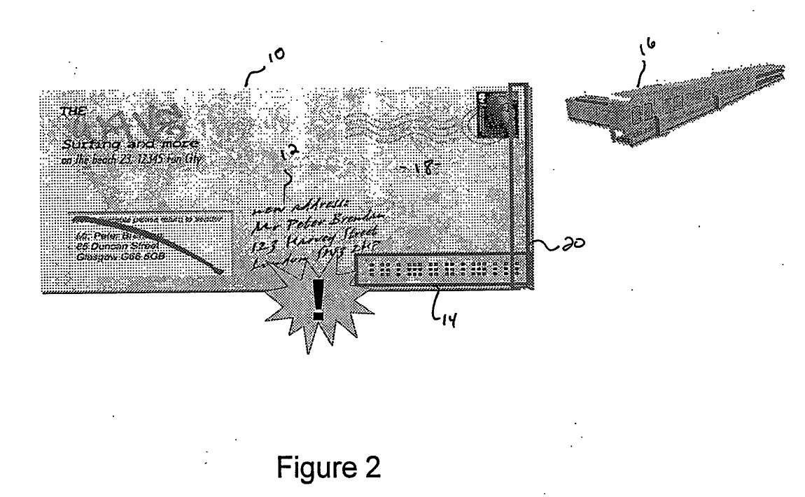

FIG. 2 depicts a mail piece 10 bearing a forwarding address 12 and a TID Barcode 14. The mail piece, as discussed above, has been reintroduced into the mail stream. The piece is handled by mechanism 16 which includes a high resolution scanner or similar image lift device (not shown) for obtaining an image of the mail piece address face 18. Such image is then forwarded to appropriate image processing means (not shown) for resolution and reading. The mechanism 16 and it various components may comprise any appropriate means known in the art. In addition to obtaining an image of the address face, the TID 14 is scanned 20 thereby providing an indication of whether the mail piece has already been previously handled.

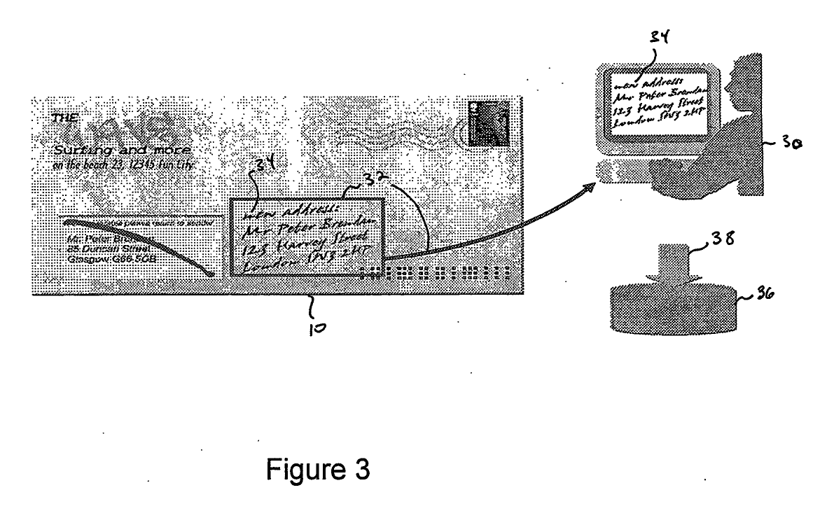

The Revenue Protection for Redirections involves the following steps: Each envelope that has been sorted via automatic equipment has a barcoded Tag Id (TID) that when scanned upon re-entry into the network (as an Ad Hoc Forward) is detected as an expired TID. Most automated worldwide posts include the use of a TIED. This flags the envelope as an exception that can be either specially image processed or displayed to an operator to confirm it is an ad hoc Forward. (FIG. 3) If no TID is detected, a scanning of the address face would be undertaken so as to determine by means other than TID detection whether the mail piece is re-entering the mail system or otherwise an ad hoc forward. Such other means are known in the art. The ad hoc forwarding address (likely handwritten) will be video coded and a database reference to determine is said addressee has paid their Redirection Fee (as further shown in FIG. 3)

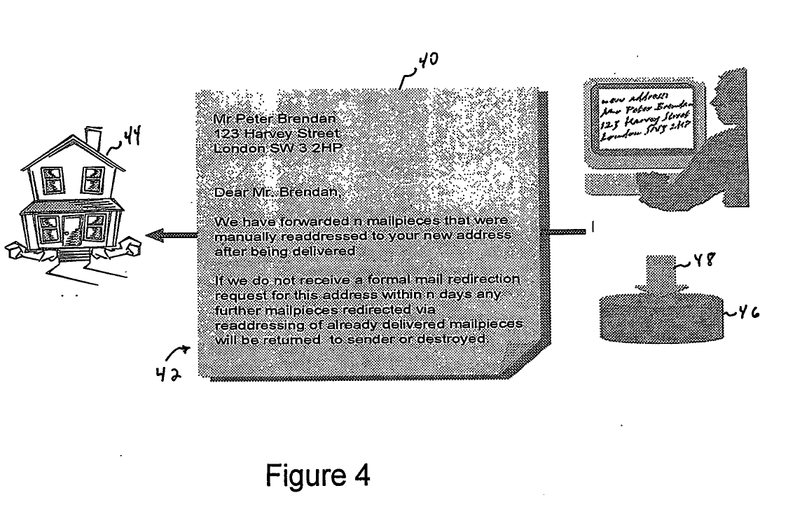

If the database of Fee Paid Redirection confirms that the subject addressee and “new address” are not authorized for Redirection, then the Ad Hoc Forward is used to record the name and addressee of the non-fee paid party and accordingly used to notify the moved party by special postal authority letter that the post will continue to forward such ad hoc mail pieces for X days and cease thereafter if no official forwarding service is requested. (FIG. 4) Alternatively the post can withhold from delivery such ad hoc forwards in the interim in anticipation of the moved party establishing a paid Forwarding account. This version of Forwarding would also require provision of some storage infrastructure for easy storage and access of such ad hoc Forwards for delivery once an account has been established or for destruction after a given grace period.

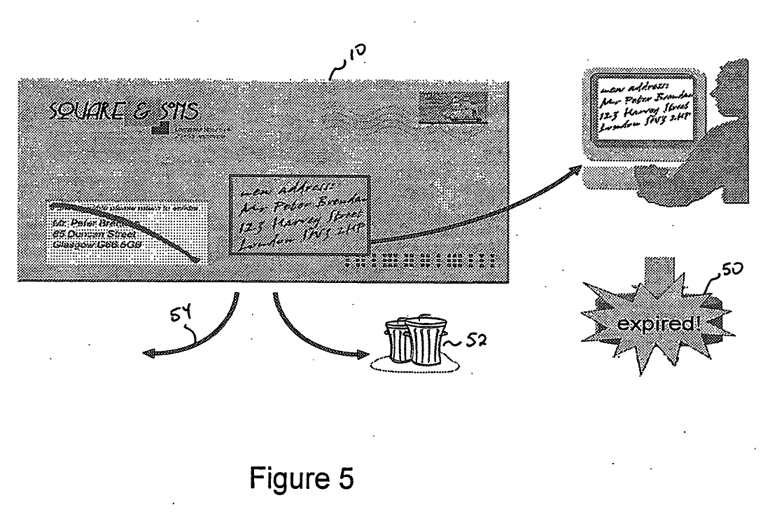

The failure of a new address party to acknowledge a request to set up a Paid Forwarding Account can be used to establish by the post a legal policy of with withholding service and destroying mail pieces. (FIG. 5)

A further enhancement of this technique allows the initial video coding of the ad hoc address to be loaded into a special directory to facilitate any future video coding by providing a special restricted directory for Interactive Video Coding processing to recover and confirm said address and addressee when further mail pieces are encountered. Such a video coding process will require the addition of a specific addressee entry step because the name will normally not be part of the ad hoc inscription.

1. A method of forwarding post, comprising the steps of:
determining if a current post destination address is expired,
if said destination address is expired, determining if an addressee of said post maintains a forwarding service, and
if said forwarding service is maintained, forwarding said post to an addressee destination address.

2. The method according to claim 1, further comprising the step of offering a forwarding service to said addressee if said addressee does not maintain a forwarding service.

3. The method according to claim 2, further comprising the step of not forwarding said post to an addressee destination address if said addressee does not maintain a forwarding service.

4. The method according to claim 3, wherein said step of not forwarding further comprises the step of destroying said post.

5. The method according to claim 4, wherein said step of not forwarding further comprises a select time delay prior to destruction of said post.

6. The method according to claim 5, wherein said step of determining, further comprises the steps of:
scanning an address face of said post for a TAG ID, and
consulting a database for records related to said TAG ID, said records indicating said TAG ID is expired.

7. An apparatus for forwarding post, comprising:
means for determining if a current post destination address is expired,
means for determining if an addressee of said post maintains a forwarding service if said destination address is expired, and
means for forwarding said post to an addressee destination address if said forwarding service is maintained.

8. The apparatus according to claim 7, further comprising means for offering a forwarding service to said addressee if said addressee does not maintain a forwarding service.

9. The apparatus according to claim 8, further comprising means for not forwarding said post to an addressee destination address if said addressee does not maintain a forwarding service.

10. The apparatus according to claim 9, wherein said means for not forwarding further comprises means for destroying said post.

11. The apparatus according to claim 10, wherein said means for not forwarding further comprises a select time delay prior to destruction of said post.

12. The apparatus according to claim 11, wherein said means for determining further comprises:
means for scanning an address face of said post for a TAG ID, and
means for consulting a database for records related to said TAG ID, said records indicating said TAG ID is expired.
